(19) United States
(12) Patent Application Publication
(10) Pub. No.: US 2024/0353534 A1
(43) Pub. Date: Oct. 24, 2024

(54) ELECTRONIC DEVICE INCLUDING DISTANCE MEASURING SENSOR

(71) Applicant: Samsung Electronics Co., Ltd., Suwon-si (KR)

(72) Inventors: Gwangho CHOI, Suwon-si (KR); Jeongseok LEE, Suwon-si (KR); Jaedeok LIM, Suwon-si (KR); Daekwang JUNG, Suwon-si (KR)

(21) Appl. No.: 18/603,622

(22) Filed: Mar. 13, 2024

Related U.S. Application Data
(63) Continuation of application No. PCT/KR2024/002881, filed on Mar. 6, 2024.

(30) Foreign Application Priority Data
Apr. 24, 2023 (KR) 10-2023-0053562
May 23, 2023 (KR) 10-2023-0066202

(51) Int. Cl. G01S 7/481

(52) U.S. Cl. CPC G01S 7/4813; G01S 7/4816

(57) ABSTRACT

An electronic device is provided. The electronic device includes a housing including a first surface, a second surface facing in a direction opposite to the first surface, and a lateral surface surrounding a space between the first surface and the second surface, a distance measuring sensor disposed in the space between the first surface and the second surface, configured to detect the distance to an external object through the second surface, and including a light emitter and a first light receiver, a substrate on which the distance measuring sensor is disposed, a sensor housing disposed on the substrate, and a shielding sheet attached to the inner surface of the sensor housing to surround the light emitter and the first light receiver and electrically connected to a ground disposed to surround the outer periphery of the substrate.

### CROSS-REFERENCE TO RELATED APPLICATION(S)

This application is a continuation application, claiming priority under § 365 (c), of an International application No. PCT/KR2024/002881, filed on Mar. 6, 2024, which is based on and claims the benefit of a Korean patent application number 10-2023-0053562, filed on Apr. 24, 2023, in the Korean Intellectual Property Office, and of a Korean patent application number 10-2023-0066202, filed on May 23, 2023, in the Korean Intellectual Property Office, the disclosure of each of which is incorporated by reference herein in its entirety.

### TECHNICAL FIELD

The disclosure relates to an electronic device including a distance measuring sensor.

### BACKGROUND ART

Recently, in line with the highlighted importance of three-dimensional content functions (for example, augmented reality (AR) function and/or virtual reality (VR) function) capable of displaying images with depth perception, electronic devices may include various sensors configured to measure the distance to external objects in order to acquire three-dimensional images with depth perception from the external objects. As an example of various sensors, a time of flight (ToF) sensor may be included. The ToF sensor may include a light emitter for emitting a laser light source to the outside, and a light receiver for detecting return light emitted from the light emitter and then reflected by an external object. For example, the ToF sensor may measure the distance to an external object by using a time difference (or phase difference) between when light is emitted from the light emitter and when the light is received by the light receiver after being reflected by the external object.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

The light emitter of the time of flight (ToF) sensor is configured to operate in a clock pulse type using a high level of TX power, and may thus be vulnerable to noise. Such noise may be manifested as electromagnetic interference (EMI) of a radiated emissions (RE) type, thereby adversely affecting the performance of an electric structure disposed inside the electronic device.

Aspects of the disclosure are to address at least the above-mentioned problems and/or disadvantages and to provide at least the advantages described below. Accordingly, an aspect of the disclosure is to provide an electronic device including a distance measuring sensor.

Additional aspects will be set forth in part in the description which follows and, in part, will be apparent from the description, or may be learned by practice of the presented embodiments.

### Solution to Problem

In accordance with an aspect of the disclosure, an electronic device is provided. The electronic device includes a distance measuring sensor to which a noise shielding structure is applied, a substrate on which a distance measuring sensor including a light emitter and a light receiver is disposed, and a sensor housing disposed on the substrate, and a shielding sheet attached to the inner surface of the sensor housing to surround the distance measuring sensor (e.g., a light emitter and/or a light receiver) and electrically connected to a ground disposed to surround the outer periphery of the substrate.

In accordance with another aspect of the disclosure, an electronic device is provided. The electronic device includes a housing including a first surface, a second surface facing in a direction opposite to the first surface, and a lateral surface surrounding a space between the first surface and the second surface, a distance measuring sensor disposed in the space between the first surface and the second surface, configured to detect the distance to an external object through the second surface, and including a light emitter and a first light receiver, a substrate on which the distance measuring sensor is placed, a sensor housing disposed on the substrate, and a shielding sheet attached to the inner surface of the sensor housing to surround the light emitter and the first light receiver and electrically connected to a ground disposed to surround the outer periphery of the substrate.

### Advantageous Effects of Invention

An electronic device including a distance measuring sensor according to an embodiment of the disclosure is advantageous in that a noise shielding structure is applied to the distance measuring sensor such that electromagnetic interference is minimized or reduced, thereby preventing performance of an electric structure disposed inside the electronic device from being degraded.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment, according to an embodiment of the disclosure;

FIG. 2A is a front perspective view of an electronic device according to an embodiment of the disclosure;

FIG. 2B is a rear perspective view of the electronic device of FIG. 2A according to an embodiment of the disclosure;

FIG. 3 is an exploded perspective view of an electronic device according to an embodiment of the disclosure;

FIG. 4A is an enlarged view of a partial region of the electronic device of FIG. 2B according to an embodiment of the disclosure;

FIG. 4B is a partial cross-sectional view of the electronic device viewed along line A-A′ of FIG. 4A according to an embodiment of the disclosure;

FIG. 5 is a partial cross-sectional view of the electronic device viewed along line B-B′ of FIG. 4A according to an embodiment of the disclosure;

FIG. 6 illustrates a distance measuring sensor disposed on a substrate, viewed from above, according to an embodiment of the disclosure;

FIG. 7 is an exploded perspective view of a distance measurement sensor, a sensor housing, and a shielding sheet disposed on a substrate, according to an embodiment of the disclosure;

FIG. 8 illustrates a distance measuring sensor, a sensor housing, and a shielding sheet attached to a substrate, according to an embodiment of the disclosure;

FIGS. 9 and 10 illustrate a process of attaching a shielding sheet to the inner surface of a sensor housing according to various embodiments of the disclosure;

FIG. 11 is a cross-sectional view of a shielding sheet according to an embodiment of the disclosure;

FIG. 12 illustrates a substrate on which a distance measuring sensor is disposed, viewed from below, according to an embodiment of the disclosure;

FIG. 13 is a partial cross-sectional view of the electronic device viewed along line A-A′ of FIG. 4A according to an embodiment of the disclosure;

FIG. 14 illustrates a support structure disposed on a substrate according to an embodiment of the disclosure;

FIG. 15 is a partial cross-sectional view of the electronic device viewed along line B-B′ in FIG. 4A in the structure of FIG. 14, according to an embodiment of the disclosure; and

FIG. 16 illustrates a support structure and a shielding sheet disposed on a substrate according to an embodiment of the disclosure.

Throughout the drawings, it should be noted that like reference numbers are used to depict the same or similar elements, features, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

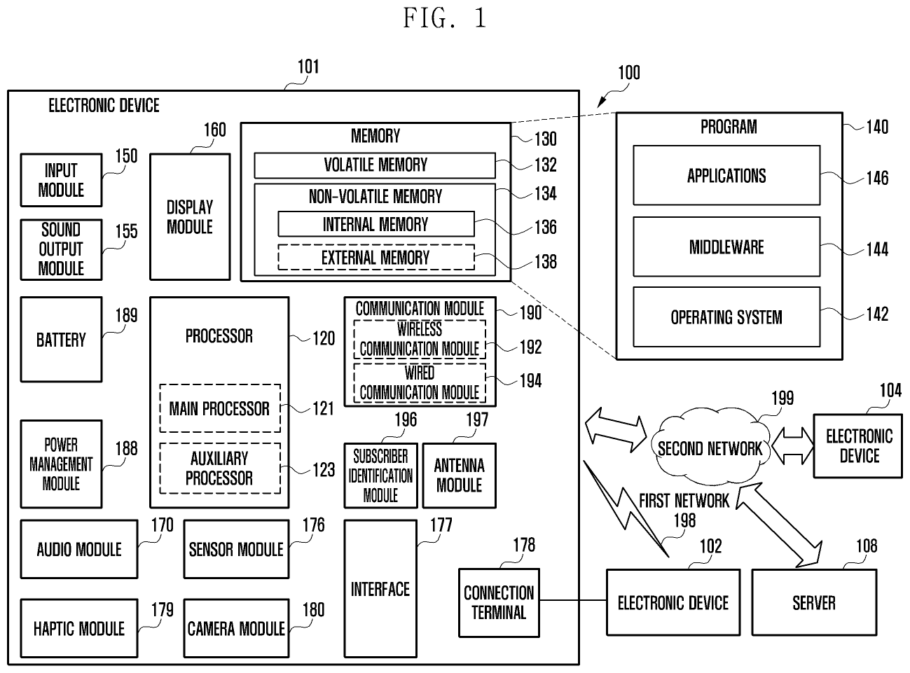

FIG. 1 is a block diagram illustrating an electronic device 101 in a network environment 100 according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connection terminal 178, a haptic module 179, a camera module 180, a power management module 188, a battery 189, a communication module 190, a subscriber identification module (SIM) 196, or an antenna module 197. In some embodiments, at least one of the components (e.g., the connection terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory 134 may include an internal memory 136 and/or an external memory 138.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) (e.g., speaker or headphone) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., through wires) or wirelessly. According to an embodiment, the interface 177 may include, for example, a high-definition multimedia interface (HDMI), a universal serial bus (USB) interface, a secure digital (SD) card interface, or an audio interface.

The connection terminal 178 may include a connector via which the electronic device 101 may be physically connected with the external electronic device (e.g., the electronic device 102). According to an embodiment, the connection terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., an application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, Wi-Fi direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN))). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large-scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form mm Wave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., an mmwave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

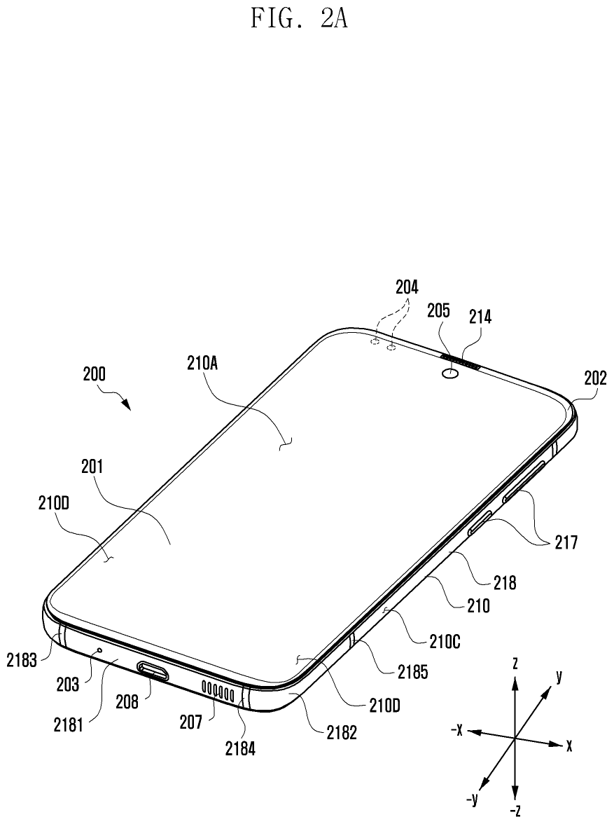

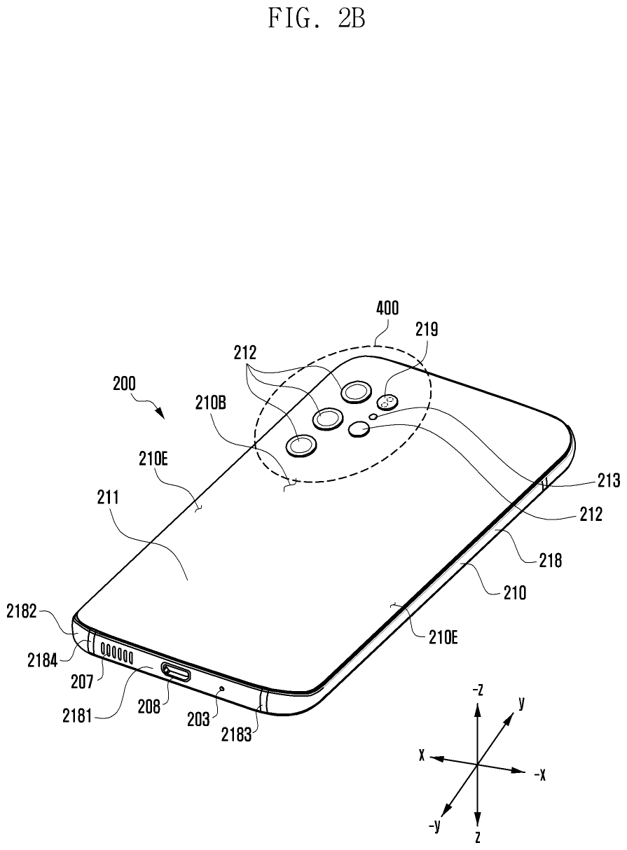

FIG. 2A is a perspective view showing a front surface of an electronic device according to an embodiment of the disclosure.

FIG. 2B is a perspective view showing a rear surface of the electronic device shown in FIG. 2A according to an embodiment of the disclosure.

The electronic device 200 of FIGS. 2A and 2B may be at least partially similar to the electronic device 101 of FIG. 1 or may further include other embodiments of an electronic device.

Referring to FIGS. 2A and 2B, an electronic device 200 may include a housing 210 that includes a first surface (or front surface) 210A, a second surface (or rear surface) 210B, and a lateral surface 210C that surrounds a space between the first surface 210A and the second surface 210B. The housing 210 may refer to a structure that forms a part of the first surface 210A, the second surface 210B, and the lateral surface 210C. The first surface 210A may be formed of a front plate 202 (e.g., a glass plate or polymer plate coated with a variety of coating layers) at least a part of which is substantially transparent. The second surface 210B may be formed of a rear plate 211 which is substantially opaque. The rear plate 211 may be formed of, for example, coated or colored glass, ceramic, polymer, metal (e.g., aluminum, stainless steel (STS), or magnesium), or any combination thereof. The lateral surface 210C may be formed of a lateral bezel structure (or “lateral member”) 218 which is combined with the front plate 202 and the rear plate 211 and includes a metal and/or polymer. The rear plate 211 and the lateral bezel structure 218 may be integrally formed and may be of the same material (e.g., a metallic material such as aluminum).

The front plate 202 may include two first regions 210D disposed at long edges thereof, respectively, and bent and extended seamlessly from the first surface 210A toward the rear plate 211. Similarly, the rear plate 211 may include two second regions 210E disposed at long edges thereof, respectively, and bent and extended seamlessly from the second surface 210B toward the front plate 202. The front plate 202 (or the rear plate 211) may include only one of the first regions 210D (or of the second regions 210E). The first regions 210D or the second regions 210E may be omitted in part. When viewed from a lateral side of the electronic device 200, the lateral bezel structure 218 may have a first thickness (or width) on a lateral side where the first region 210D or the second region 210E is not included, and may have a second thickness, being less than the first thickness, on another lateral side where the first region 210D or the second region 210E is included.

The electronic device 200 may include at least one of a display 201 (e.g., a display module 160 of FIG. 1), an input device 203 (e.g., an input module 150 of FIG. 1), sound output devices 207 and 214 (e.g., a sound output module 155 of FIG. 1), sensor modules 204 and 219 (e.g., a sensor module 176 of FIG. 1), camera modules 205, 212 and 213 (e.g., a camera module 180 of FIG. 1), a key input device 217, an indicator, and a connector hole 208 (e.g., a connection terminal 178 of FIG. 1). The electronic device 200 may omit at least one (e.g., the key input device 217 or the indicator) of the above components, or may further include other components.

The display 201 may be exposed through a substantial portion of the front plate 202, for example. At least a part of the display 201 may be exposed through the front plate 202 that forms the first surface 210A and the first region 210D of the lateral surface 210C. The display 201 may be combined with, or adjacent to, a touch sensing circuit, a pressure sensor capable of measuring the touch strength (pressure), and/or a digitizer for detecting a stylus pen. At least a part of the sensor modules 204 and 219 and/or at least a part of the key input device 217 may be disposed in the first region 210D and/or the second region 210E.

The input device 203 may include a microphone. In some embodiments, the input device 203 may include a plurality of microphones arranged to sense the direction of the sound. The sound output devices 207 and 214 may include speakers. The speakers may include an external speaker 207 and a receiver 214 for a call. In some embodiments, the microphone, the speakers, and the connector hole 208 are disposed in the space of the electronic device 200 and may be exposed to the external environment through at least one hole formed in the housing 210. A hole formed in the housing 210 may be used in common for the microphone and speakers. The sound output devices 207 and 214 may include a speaker (e.g., a piezo speaker) that operates while excluding a hole formed in the housing 210.

The sensor modules 204 and 219 may generate electrical signals or data corresponding to an internal operating state of the electronic device 200 or to an external environmental condition. The sensor modules 204 and 219 may include a first sensor module 204 (e.g., a proximity sensor) and/or a second sensor module (e.g., a fingerprint sensor) disposed on the first surface 210A of the housing 210, and/or a third sensor module 219 (e.g., a heart rate monitor (HRM) sensor) disposed on the second surface 210B of the housing 210. The fingerprint sensor may be disposed on the first surface 210A of the housing 210. A fingerprint sensor (e.g., an ultrasonic method or an optical fingerprint sensor) may be disposed under the display 201 of the first surface 210A. The fingerprint sensor may be disposed on the second surface 210B as well as the first surface 210A (e.g., the display 201) of the housing 210. The electronic device 200 may further include at least one of a gesture sensor, a gyro sensor, an air pressure sensor, a magnetic sensor, an acceleration sensor, a grip sensor, a color sensor, an infrared (IR) sensor, a biometric sensor, a temperature sensor, a humidity sensor, or an illuminance sensor.

The camera modules 205, 212 and 213 may include a first camera device (e.g., camera module 205) disposed on the first surface 210A of the electronic device 101, and a second camera device (e.g., camera module 212) and/or a flash (e.g., camera module 213) disposed on the second surface 210B. The camera module 205 or the camera module 212 may include one or more lenses, an image sensor, and/or an image signal processor. The flash (e.g., camera module 213) may include, for example, a light emitting diode or a xenon lamp. Two or more lenses (infrared cameras, wide angle and telephoto lenses) and image sensors may be disposed on one side of the electronic device 200.

The key input device 217 may be disposed on the lateral surface 210C of the housing 210. The electronic device 200 may not include some or all of the key input device 217 described above, and the key input device 217 which is not included may be implemented in another form such as a soft key on the display 201. The key input device 217 may include the sensor module disposed on the second surface 210B of the housing 210. In another embodiment, the key input device 217 may be implemented using a pressure sensor included in the display 201.

The indicator may be disposed on the first surface 210A of the housing 210. For example, the indicator may provide status information of the electronic device 200 in an optical form. The indicator may provide a light source associated with the operation of the camera module 205. The indicator may include, for example, a light emitting diode (LED), an infrared (IR) LED, or a xenon lamp.

The connector hole 208 may include a first connector hole adapted for a connector (e.g., a universal serial bus (USB) connector or an interface connector port module) for transmitting and receiving power and/or data to and from an external electronic device. The connector hole 208 may include a second connector hole adapted for a connector (e.g., an earphone jack) for transmitting and receiving an audio signal to and from an external electronic device.

Some camera module 205 of camera modules 205 and 212, some sensor module 204 of sensor modules 204 and 219, or an indicator may be arranged to be exposed through a display 201. For example, the camera module 205, the sensor module 204, or the indicator may be arranged in the internal space of an electronic device 200 so as to be brought into contact with an external environment through an opening of the display 201, which is perforated up to a front plate 202. The area facing the camera module 205 of the display 201 may be formed as a transparent area having a designated transmittance as a part of an area displaying content. The transmissive region may have a transmittance ranging from about 5% to about 20%. Such a transmissive region may include a region overlapping an effective region (e.g., an angle of view region) of the camera module 205 through which light for generating an image by an image sensor passes. The transparent area of the display 201 may include an area having a lower pixel density or wiring density or both than the surrounding area. The transmissive area may replace the aforementioned opening. The camera module 205 may include an under-display camera (UDC). The sensor module 204 may be arranged to perform functions without being visually exposed through the display 201 in the internal space of the electronic device 200. For example, in this case, an area of the display 201 facing the sensor module may not require a perforated opening.

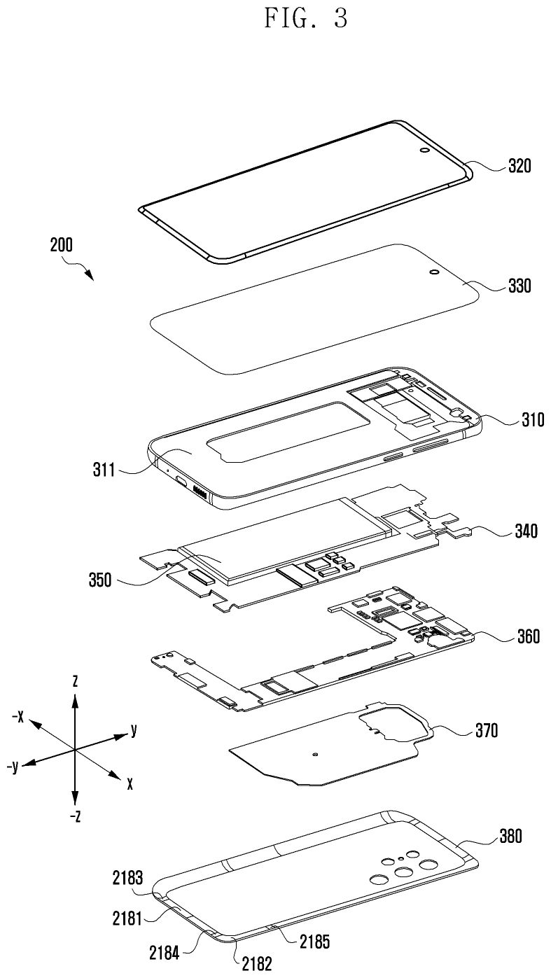

According to various embodiments, the electronic device 200 may include an antenna formed through at least a portion of a conductive member included in the lateral member 218. For example, the antenna may be formed by electrically connecting at least one conductive portion 2181 and 2182 segmented through at least one non-conductive portion 2183, 2184, and 2185 disposed on the lateral member 218 to a wireless communication circuit (e.g., the wireless communication module 192 of FIG. 1). For example, the first conductive portion 2181 is arranged to be segmented through the first non-conductive portion 2183 and the second non-conductive portion 2184 spaced apart at a specified interval, and may be electrically connected to the wireless communication circuit (e.g., the wireless communication module 192 of FIG. 1) disposed on a substrate (e.g., the printed circuit board 340 of FIG. 3). The second conductive portion 2182 is arranged to be segmented through the second non-conductive portion 2184 and the third non-conductive portion 2185 spaced apart at a specified interval, and may be electrically connected to the wireless communication circuit (e.g., the wireless communication module 192 of FIG. 1) disposed on a substrate (e.g., the printed circuit board 340 of FIG. 3).

FIG. 3 is an exploded perspective view of the electronic device according to an embodiment of the disclosure.

The electronic device 200 shown in FIG. 3 may be similar, at least in part, to the electronic device 101 in FIG. 1 or the electronic device 200 in FIGS. 2A and 2B, or may further include another embodiment of the electronic device.

Referring to FIG. 3, an electronic device 200 may include a lateral member 310 (e.g., lateral bezel structure), a first support member 311 (e.g., a bracket or support structure), a front plate 320 (e.g., a front cover) (e.g., a front plate 202 of FIG. 2A), a display 330 (e.g., a display 201 of FIG. 2A), a printed circuit board (PCB) 340, a battery 350, a second support member 360 (e.g., a rear case), an antenna 370, and a rear plate 380 (e.g., a rear cover) (e.g., a rear plate 211 of FIG. 2A). The electronic device 200 may omit at least one (e.g., the first support member 311 or the second support member 360) of the above components or may further include another component. Some components of the electronic device 200 may be the same as or similar to those of the electronic device 200 shown in FIG. 2A or 2B, thus, descriptions thereof are omitted below.

The first support member 311 is disposed inside the electronic device 200 and may be connected to, or integrated with, the lateral member 310. The first support member 311 may be formed of, for example, a metallic material and/or a non-metal (e.g., polymer) material. The first support member 311 may be combined with the display 330 at one side thereof and also combined with a PCB 340 at the other side thereof. On a PCB 340, a processor (e.g., a processor 120 of FIG. 1), a memory (e.g., a memory 130 of FIG. 1), and/or an interface (e.g., an interface 177 of FIG. 1) may be mounted.

The processor may include, for example, one or more of a central processing unit (CPU), an application processor (AP), a graphics processing unit (GPU), an image signal processor (ISP), a sensor hub processor, or a communications processor (CP).

The memory may include, for example, one or more of a volatile memory (e.g., a volatile memory 132 of FIG. 1) and a non-volatile memory (e.g., a non-volatile memory 134 of FIG. 1).

The interface may include, for example, a high definition multimedia interface (HDMI), a USB interface, a secure digital (SD) card interface, and/or an audio interface. The interface may electrically or physically connect the electronic device 200 with an external electronic device and may include a USB connector, an SD card/multimedia card (MMC) connector, or an audio connector.

The battery 350 (e.g., a battery 189 of FIG. 1) is a device for supplying power to at least one component of the electronic device 200, and may include, for example, a non-rechargeable primary battery, a rechargeable secondary battery, or a fuel cell. At least a part of the battery 350 may be disposed on substantially the same plane as a PCB 340. The battery 350 may be integrally disposed within the electronic device 200, and may be detachably disposed from the electronic device 200.

The antenna 370 may be disposed between the rear plate 380 and the battery 350. The antenna 370 may include, for example, a near field communication (NFC) antenna, a wireless charging antenna, and/or a magnetic secure transmission (MST) antenna. The antenna 370 may perform short-range communication with an external device, or transmit and receive power required for charging wirelessly. An antenna structure may be formed by a part or combination of the lateral member 310 and/or the first support member 311.

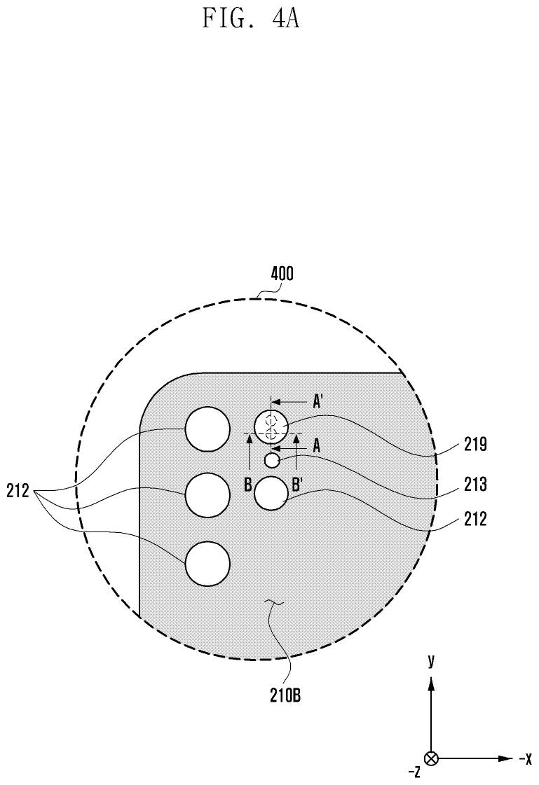

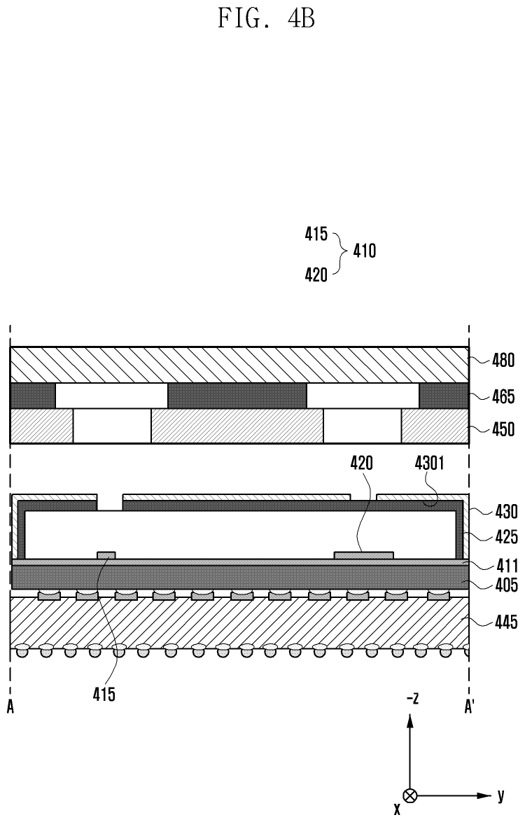

FIG. 4A is an enlarged view of a partial region 400 of the electronic device of FIG. 2B according to an embodiment of the disclosure.

FIG. 4B is a partial cross-sectional view of the electronic device viewed along line A-A′ of FIG. 4A according to an embodiment of the disclosure.

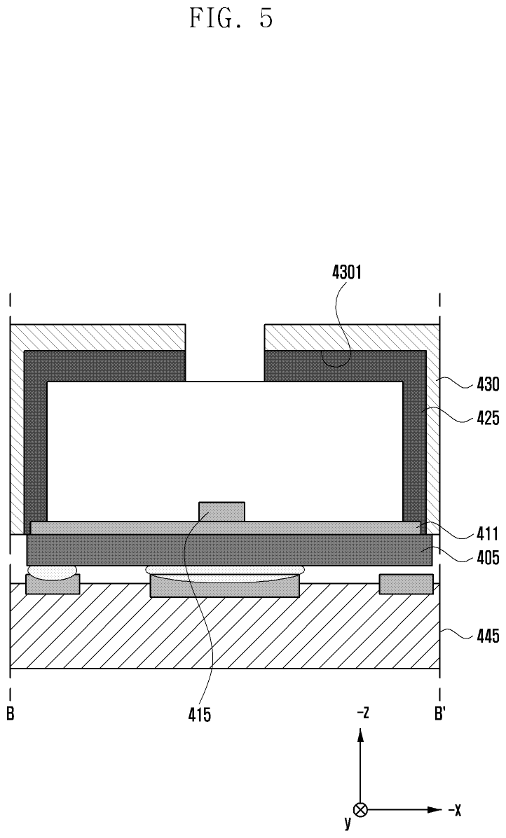

FIG. 5 is a partial cross-sectional view of the electronic device viewed along line B-B′ of FIG. 4A according to an embodiment of the disclosure.

Referring to FIGS. 4A, 4B, and 5, the second surface (e.g., the second surface 210B of FIG. 2B) (or the rear surface) of the electronic device (e.g., the electronic device 200 of FIGS. 2A, 2B, and 3) is a window 480 and a decoration part 450 disposed to protect the sensor module (e.g., the sensor module 219 of FIG. 2B) disposed on the second surface 210B from external shock or from being scratched. For example, the window 480 and the decoration part 450 may be placed in a position corresponding to the region where the sensor module 219 is placed. The window 480 may be made of a transparent material, but is not limited thereto.

In an embodiment, the decoration part 450 may be disposed on the rear surface (e.g., the surface facing the z-axis direction) of the window 480.

In an embodiment, an adhesive layer 465 may be disposed between the window 480 and the decoration part 450. The window 480 and the decoration part 450 may be adhered to each other through an adhesive layer 465. In an embodiment, the adhesive layer 465 may include pressure sensitive adhesive (PSA), optical clear adhesive (OPA), heat-reactive adhesive, general adhesive, or double-sided tape, but is not limited thereto.

In an embodiment, a distance measuring sensor 410 configured to detect the distance to an external object may be disposed on the rear surface (e.g., the surface facing the z-axis direction) of the decoration part 450. For example, the distance measuring sensor 410 may include a time of flight (ToF) sensor, but is not limited thereto.

In an embodiment, the distance measuring sensor 410 may be disposed on one surface (e.g., the surface facing the −z-axis) of a sensor die 411. In an embodiment, the distance measuring sensor 410 may include a light emitter 415 and a first light receiver 420. The light emitter 415 may emit light to the outside. In an embodiment, the light emitter 415 may include various types of light emitting elements. For example, the light emitter 415 may include a vertical cavity surface emitting laser (VCSEL). The first light receiver 420 may receive light returned when the light emitted by the light emitter 415 is reflected by an external object. For example, the first light receiver 420 may include one or more light detectors (or sensors) (e.g., photo diode (PD)) capable of detecting light in one or more wavelength bands. For example, the first light receiver 420 may include a single-photon avalanche diode (SPAD) sensor. In an embodiment, the first light receiver 420 may be disposed on one surface of the sensor die 411 to be adjacent to the light emitter 415.

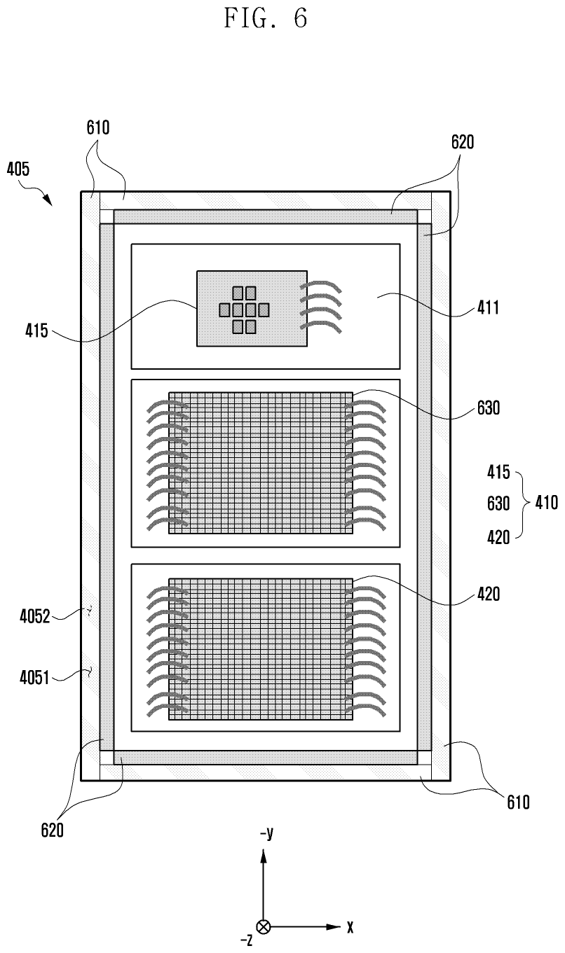

In an embodiment, although not shown, the distance measuring sensor 410 may further include a second light receiver (e.g., the second light receiver 630 of FIG. 6). For example, the second light receiver 630 may identify (or measure) the time during which the light is emitted to the outside by the light emitter 415.

In an embodiment, the second light receiver 630 may be disposed between the light emitter 415 and the first light receiver 420 on one surface (e.g., the surface facing the −z-axis) of the sensor die 411. For example, the second light receiver 630 may be disposed between the light emitter 415 and the first light receiver 420 and be close to the light emitter 415 to more precisely measure the time during which the light is emitted to the outside by the light emitter 415.

In an embodiment, the second light receiver 630 may include a single-photon avalanche diode (SPAD) sensor.

In FIGS. 6, 7, 14, and 16 described later according to various embodiments, the size of the second light receiver 630 is shown to be the same as the size of the first light receiver 420, but the second light receiver 630 may be smaller than the size of the first light receiver 420. For example, the location and/or size of the second light receiver 630 may be determined based on the height of the sensor housing 430 and/or the angle of the light emitted by the light emitter 415. However, it is not limited thereto, and the location and/or size of the second light receiver 630 may vary depending on the design of the distance measuring sensor 410.

In an embodiment, the sensor die 411 on which the distance measuring sensor 410 is disposed may be disposed on the substrate 405.

In an embodiment, the electronic device 200 may include an interposer 445 that is fixed to the substrate 405 and applied for electrical connection with another substrate (e.g., the printed circuit board 340 of FIG. 3).

In an embodiment, the electronic device 200 may include the sensor housing 430 disposed (or fixed to) on the substrate 405. For example, the sensor housing 430 may be placed (or fixed to) on the substrate 405 to surround the light emitter 415, the first light receiver 420, and the second light receiver 630 of the distance measuring sensor 410.

In an embodiment, the electronic device 200 may include a shielding sheet 425 attached to the inner surface 4301 of the sensor housing 430. For example, the shielding sheet 425 may be attached to the inner surface 4301 of the sensor housing 430 while surrounding the light emitter 415, the first light receiver 420, and the second light receiver 630 of the distance measuring sensor 410. In an embodiment, the shielding sheet 425 may be a film type, but is not limited thereto.

FIG. 6 illustrates the distance measuring sensor 410 disposed on the substrate 405, viewed from above, according to an embodiment of the disclosure.

Referring to FIG. 6, the electronic device (e.g., the electronic device 200 of FIGS. 2A, 2B, and 3) may include the distance measuring sensor 410 configured to detect the distance to an external object. The distance measuring sensor 410 may include the light emitter 415, the first light receiver 420, and/or the second light receiver 630. The light emitter 415, the first light receiver 420, and/or the second light receiver 630 of the distance measuring sensor 410 may be disposed on one surface (e.g., the surface facing the −z axis) of the sensor die 411.

In an embodiment, the sensor die 411 on which the distance measuring sensor 410 is disposed may be stacked (or placed) on the substrate 405. In an embodiment, the substrate 405 may include a first substrate surface 4051 and a second substrate surface 4052 facing in a direction opposite to the first substrate surface 4051. The sensor die 411 on which the distance measuring sensor 410 is disposed may be stacked (or placed) on the first substrate surface 4051 of the substrate 405.

Referring to FIGS. 4B and 5, the electronic device 200 may include a sensor housing (e.g., the sensor housing 430 of FIG. 4B) disposed (or fixed to) on the substrate 405, and a shielding sheet (e.g., the shielding sheet 425 of FIG. 4B) attached to the inner surface 4301 (e.g., the inner surface 4301 of FIG. 4B) of the sensor housing. 430.

In an embodiment, the substrate 405 may include an attachment region 610 and a ground 620 disposed to surround the outer periphery of the substrate 405. In an embodiment, the ground 620 may be disposed closer to the inner side than the attachment region 610 while surrounding the outer periphery of the substrate 405.

In an embodiment, the sensor housing 430 disposed (or fixed to) on the substrate 405 may be attached to the substrate 405 through the attachment region 610.

In an embodiment, at least a part of the shielding sheet 425 attached to the inner surface 4301 of the sensor housing 430 may be attached to the substrate 405 through the attachment region 610, and at least another part of the shielding sheet 425 may be electrically connected to the ground 620 of the substrate 405.

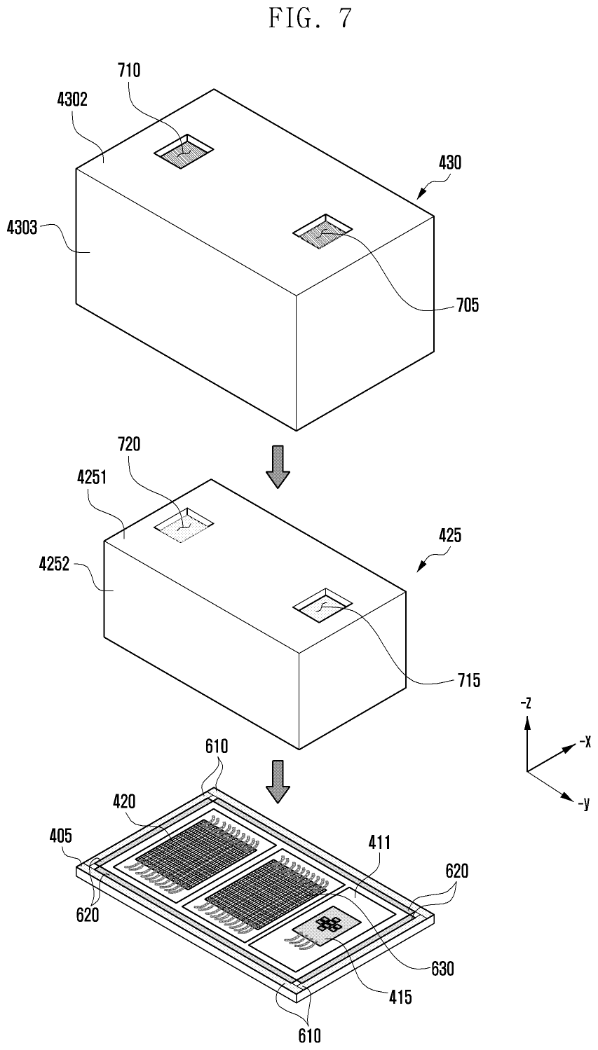

FIG. 7 is an exploded perspective view of the distance measurement sensor 410, the sensor housing 430, and the shielding sheet 425 disposed on the substrate 405, according to an embodiment of the disclosure.

Referring to FIG. 7, the electronic device (e.g., the electronic device 200 of FIGS. 2A, 2B, and 3) may include the distance measuring sensor 410 configured to detect the distance to an external object. The distance measuring sensor 410 may be disposed on one surface (e.g., the surface facing the −z-axis) of the sensor die 411. The distance measuring sensor 410 may include a light emitter 415, a first light receiver 420, and/or a second light receiver 630. In an embodiment, the sensor die 411 on which the distance measuring sensor 410 is disposed may be stacked (or placed) on the substrate 405.

In an embodiment, the substrate 405 may include the attachment region 610 disposed to surround the outer periphery of the substrate 405. In addition, the substrate 405 may include the ground 620 disposed closer to the inner side than the attachment region 610 while surrounding the outer periphery of the substrate 405.

In an embodiment, the electronic device 200 may include the sensor housing 430 mounted on the substrate 405.

In an embodiment, the sensor housing 430 may include a first upper surface 4302 and a first lateral part 4303 extending along the edge of the first upper surface 4302 to have a predetermined depth. In an embodiment, the sensor housing 430 may include a first opening 705 and a second opening 710 disposed through the first upper surface 4302. In an embodiment, the first opening 705 of the sensor housing 430 may be disposed at a position corresponding to the light emitter 415 of the distance measuring sensor 410. The second opening 710 of the sensor housing 430 may be disposed at a position corresponding to the first light receiver 420 of the distance measuring sensor 410.

In an embodiment, the sensor housing 430 may be fixed to the attachment region 610 of the substrate 405 through bonding, but is not limited thereto, and the sensor housing 430 may also be fixed to the attachment region 610 of the substrate 405 through taping or fusion.

In an embodiment, the electronic device 200 may include the shielding sheet 425 attached to the inner surface 4301 of the sensor housing 430 to surround the light emitter 415 and the first light receiver 420 of the distance measuring sensor 410.

In an embodiment, the shielding sheet 425 may include a second upper surface 4251 and a second lateral part 4252 extending along the edge of the second upper surface 4251 to have a predetermined depth. In an embodiment, the shielding sheet 425 may include a third opening 715 and a fourth opening 720 disposed through the second upper surface 4251. In an embodiment, the third opening 715 of the shielding sheet 425 may be disposed at a position corresponding to the light emitter 415 of the distance measuring sensor 410. The fourth opening 720 of the shielding sheet 425 may be disposed at a position corresponding to the first light receiver 420 of the distance measuring sensor 410.

In an embodiment, the shielding sheet 425 may be fixed to the attachment region 610 of the substrate 405 through bonding, but is not limited thereto, and the shielding sheet 425 may also be fixed to the attachment region 610 of the substrate 405 through taping or fusion.

In an embodiment, a path through which light emitted from the light emitter 415 may move to the outside of the shielding sheet 425 and the sensor housing 430 may be provided due to the first opening 705 of the sensor housing 430 and the third opening 715 of the shielding sheet 425 formed at a position corresponding to the light emitter 415 of the distance measuring sensor 410. For example, a path through which the light emitted from the light emitter 415 may move into the sensor housing 430 and the shielding sheet 425 after being reflected by an external object may be provided by the second opening 710 of the sensor housing 430 and the fourth opening 720 of the shielding sheet 425 formed at a position corresponding to the first light receiver 420 of the distance measuring sensor 410.

In an embodiment, the shielding sheet 425 fixed to the attachment region 610 of the substrate 405 may be electrically connected to the ground 620 formed on the substrate 405.

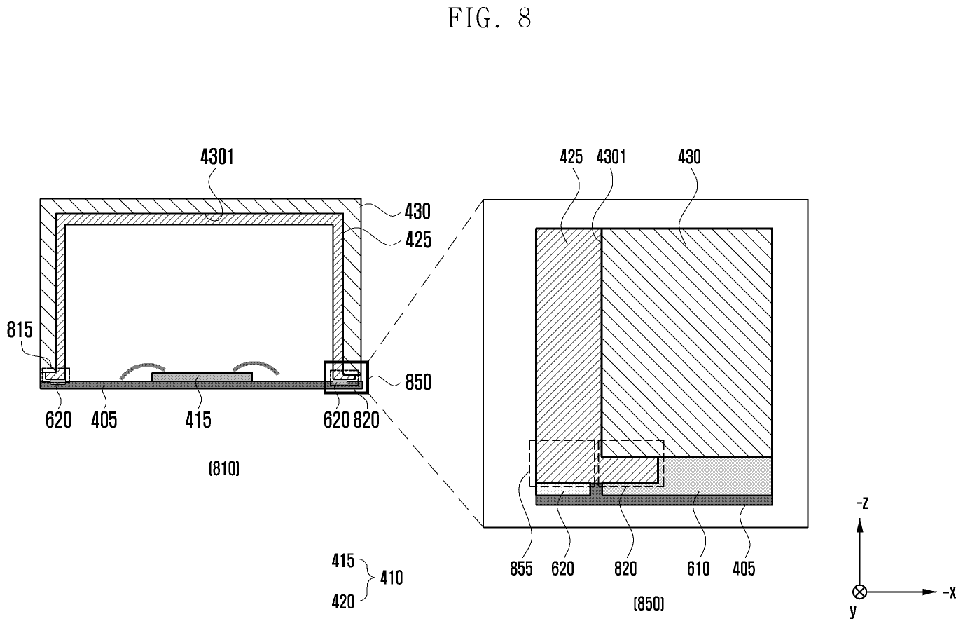

FIG. 8 illustrates the distance measuring sensor 410, the sensor housing 430, and the shielding sheet 425 attached to the substrate 405, according to an embodiment of the disclosure.

Referring to FIG. 8, as shown in reference numeral <810>, an electronic device (e.g., the electronic device 200 of FIGS. 2A, 2B, and 3) may include the substrate 405, the distance measuring sensor 410 disposed on the substrate 405, the sensor housing 430 mounted on the substrate 405, and/or the shielding sheet 425 attached to the inner surface 4301 of the sensor housing 430.

In an embodiment, the outer edge of the shielding sheet 425 may have bent parts 815 and 820 which have a predetermined length and are bent from the ends toward the sensor housing 430.

According to various embodiments, reference numeral <850> is an enlarged view of a partial region including the bent part 820 of the shielding sheet 425, the sensor housing 430, and the substrate 405. As shown in reference numeral <850>, the outer edge of the shielding sheet 425 may have a bent part 820 which have a predetermined length and are bent from the end toward the sensor housing 430. At least a part 855 of the bottom surface of the shielding sheet 425 may be electrically connected to the ground 620 disposed to surround the outer periphery of the substrate 405, and at least another part of the bottom surface of the shielding sheet 425, for example, the bent part 820 may be attached to the attachment region 610 disposed to surround the outer periphery of the substrate 405.

In an embodiment, the outer edge of the shielding sheet 425 may include the bent parts 815 and 820 which have a predetermined length and are bent from the ends toward the sensor housing 430, and the shielding sheet 425 may be prevented from lifting due to the bent parts 815 and 820 attached to the attachment region 610 disposed on the substrate 405.

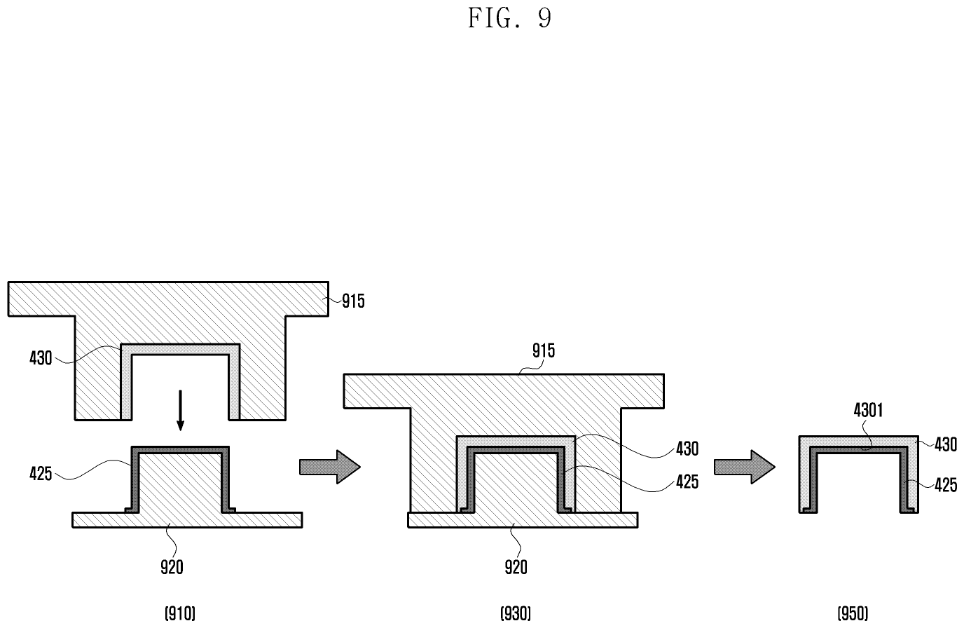

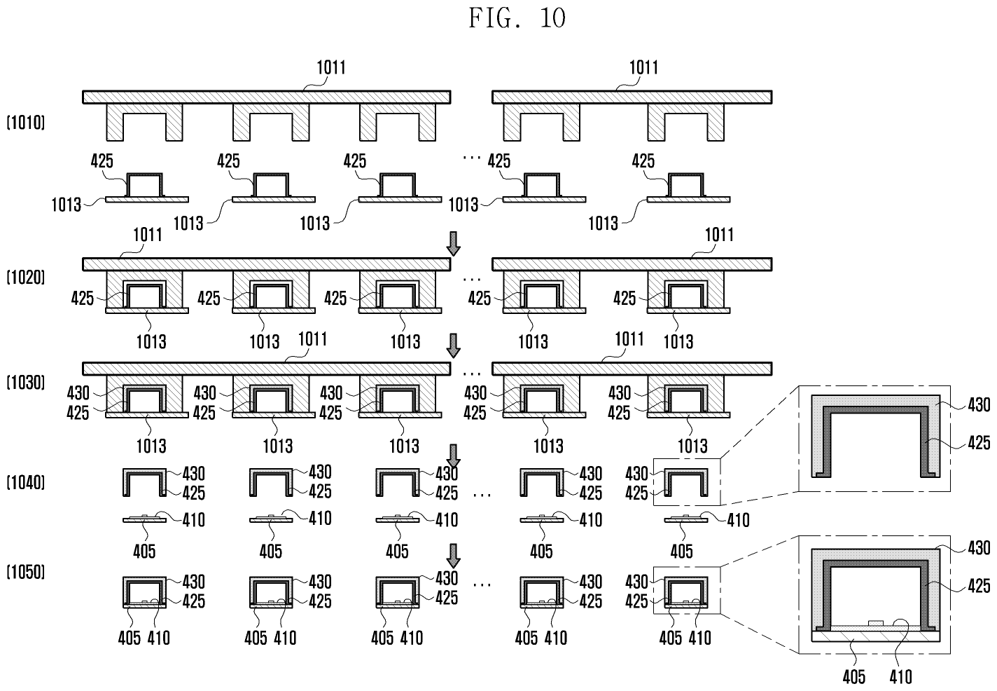

FIGS. 9 and 10 illustrate a process of attaching the shielding sheet 425 to the inner surface of the sensor housing 430 according to various embodiments of the disclosure.

Referring to FIG. 9, as shown in reference number <910>, the sensor housing 430 may be placed on an upper jig 915, and the shielding sheet 425 may be placed on a lower jig 920.

In an embodiment, as shown in reference numeral <930>, the upper jig 915 on which the sensor housing 430 is disposed and the lower jig 920 on which the shielding sheet 425 is disposed may be pressed. For example, thermocompression conditions may include a pressure of about 310 N, a temperature of about 190 degrees, and/or an overlap of about 0.3 t., but is not limited thereto.

As shown in reference numeral <950>, the shielding sheet 425 may be attached to the inner surface 4301 of the sensor housing 430 according to the above-described conditions.

In an embodiment, the shielding sheet 425 may be a film type. The film-type shielding sheet 425 attached to the inner surface 4301 of the sensor housing 430 may prevent the shielding sheet 425 from tearing by external impact.

Referring to FIG. 10 according to various embodiments, FIG. 10 illustrates a method of attaching the shielding sheet 425 through a molding process by using an array structure.

In an embodiment, as shown in reference number <1010>, the shielding sheet 425 may be placed on the lower jig 1013. In this state, as shown in reference number <1020>, the upper jig 1011 may be lowered such that the upper jig 1011 may press the lower jig 1013 on which the shielding sheet 425 is disposed. A mold may be injected after lowering the upper jig 1011.

In an embodiment, after injecting the mold, as shown in reference numeral <1030>, a mold cure may be performed, and the mold and shielding sheet 425 may be separated from the upper jig 1011 and the lower jig 1013.

In an embodiment, as shown in reference number <1040>, the sensor housing 430 disposed through a molding process according to reference number <1020> and the shielding sheet 425 attached to the sensor housing 430 may be attached to the substrate 405 on which the distance measuring sensor 410 is placed.

In an embodiment, as shown in reference number <1050>, production of the distance measuring sensor 410 may be completed by attaching the sensor housing 430 and the shielding sheet 425 attached to the sensor housing 430 to the substrate 405 on which the distance measuring sensor 410 is disposed.

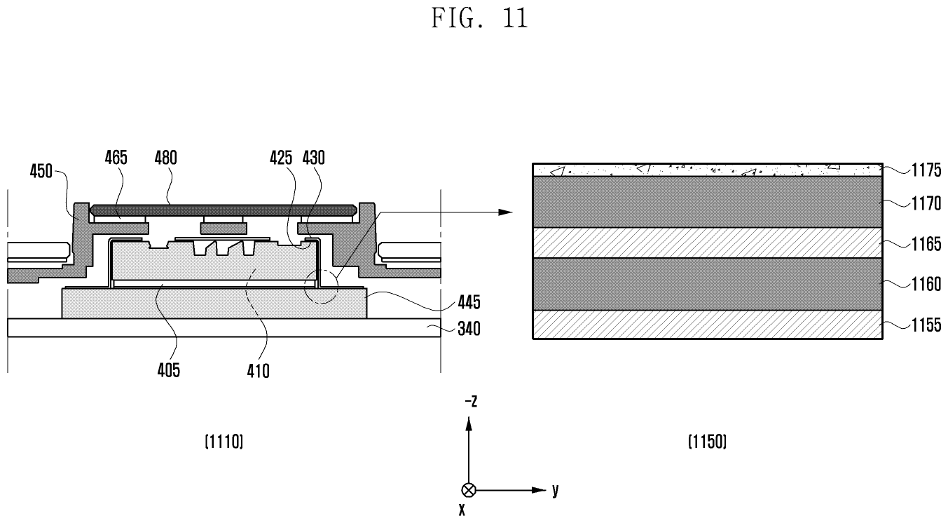

FIG. 11 is a cross-sectional view of the shielding sheet 425 according to an embodiment of the disclosure.

Referring to FIG. 11, reference number <1110> illustrates a structure including an interposer (e.g., the interposer 445 of FIG. 4B), a substrate (e.g., the substrate 405 of FIG. 4B), a distance measuring sensor (e.g., the distance measuring sensor 410 of FIG. 4B), a shielding sheet (e.g., the shielding sheet 425 of FIG. 4B), a sensor housing (e.g., the sensor housing 430 of FIG. 4B), an adhesive layer (e.g., the adhesive layer 465 of FIG. 4B), and/or a window (e.g., the window 480 of FIG. 4B) which are stacked in this order. Reference number <1150> is an enlarged view of the shielding sheet 425 in reference number <1110>.

Since the stacked structure indicated by reference number <1110> according to various embodiments is the same as the stacked structure of FIG. 4B described above, the description thereof may be replaced with the description related to FIG. 4B. In the following description of FIG. 11, only the configuration different from FIG. 4B will be described.

In an embodiment, the shielding sheet 425 may include a first adhesive layer 1155, a first shielding layer 1160, a second adhesive layer 1165, a second shielding layer 1170, and/or a cover layer 1175.

In an embodiment, the first shielding layer 1160 may be disposed on the first adhesive layer 1155 (e.g., the surface facing the −z-direction).

In an embodiment, the second adhesive layer 1165 may be disposed on the first shielding layer 1160 (e.g., the surface facing the −z-direction). The second shielding layer 1170 may be disposed on the second adhesive layer 1165 (e.g., the surface facing the −z-direction). The second adhesive layer 1165 may attach the first shielding layer 1160 to the second shielding layer 1170.

In an embodiment, the second adhesive layer 1165 may be formed substantially the same as the first adhesive layer 1155. In an embodiment, the first adhesive layer 1155 and the second adhesive layer 1165 may include an adhesive material. For example, the first adhesive layer 1155 and the second adhesive layer 1165 may include a pressure sensitive adhesive (PSA).

In an embodiment, the second shielding layer 1170 may be formed substantially the same as the first shielding layer 1160. For example, the first shielding layer 1160 and the second shielding layer 1170 may include at least one of nanofiber and metal electrically connected to the ground (e.g., the ground 620 of FIGS. 6 to 8) disposed on the substrate 405.

In an embodiment, the cover layer 1175 may be disposed on the second shielding layer 1170 (e.g., the surface facing the −z-direction). For example, the cover layer 1175 may be exposed to the outside of the shielding sheet 425. For example, the cover layer 1175 may include carbon black.

In an embodiment, the thickness of the first adhesive layer 1155 may be about 10 μm, the thickness of the first shielding layer 1160 may be about 20 μm, and the thickness of the second adhesive layer 1165 may be about 10 μm, and the thickness of the second shielding layer 1170 may be about 20 μm, but are not limited thereto. For example, the thickness of the first adhesive layer 1155, the thickness of the first shielding layer 1160, the thickness of the second adhesive layer 1165, and/or the thickness of the second shielding layer 1170 may vary depending on the stacked structure to withstand reflow, the location at which the adhesive layer (e.g., the first adhesive layer 1155 and/or the second adhesive layer 1165) is attached, and/or the degree of ratio to minimize or reduce deformation due to heat.

Referring to FIG. 11 according to various embodiments, the shielding layers 1160 and 1170, such as nanofibers, may be printed using a thermal transfer method to produce a film type shielding sheet 425, thereby not only preventing thermal deformation caused by a reflow process but also preventing loss of adhesion or deterioration of shielding performance.

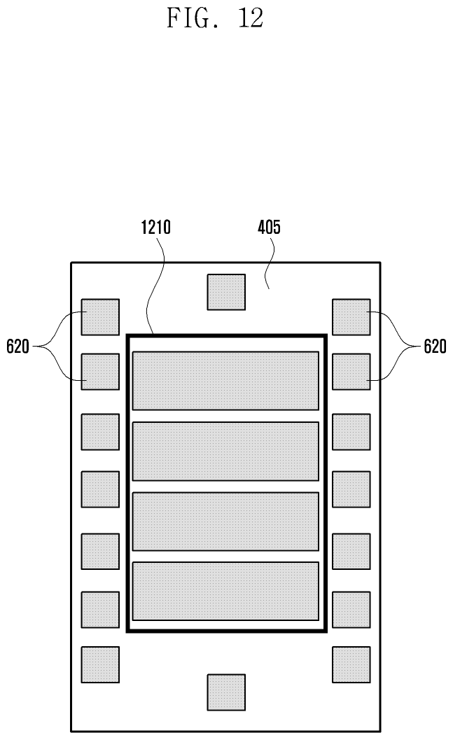

FIG. 12 illustrates the substrate 405 on which the distance measuring sensor 410 is disposed, viewed from below, according to an embodiment of the disclosure.

Referring to FIG. 12, an electronic device (e.g., the electronic device 200 of FIGS. 2A, 2B, and 3) may include a distance measuring sensor (e.g., the distance measuring sensor 410 of FIG. 4B) (e.g., a ToF sensor) configured to detect the distance to an external object. The distance measuring sensor 410 may be disposed on one surface of a sensor die (e.g., the sensor die 411 of FIG. 4B). The sensor die 411 on which the distance measuring sensor 410 is disposed may be disposed on the substrate 405.

In an embodiment, the substrate 405 may include the ground 620 disposed to surround the outer periphery of the substrate 405. In addition, the substrate 405 may further include a plurality of grounds 1210 disposed in the central region of the substrate 405.

In an embodiment, a shielding sheet (e.g., the shielding sheet 425 of FIG. 4B) may be electrically connected to the ground 620 and the plurality of grounds 1210 disposed on the substrate 405. In FIG. 12 according to various embodiments, the substrate 405 may include the ground 620 disposed to surround the outer periphery of the substrate 405 and the plurality of grounds 1210 disposed in the central region of the substrate 405 to increase thermal diffusivity, thereby increasing heat dissipation efficiency. Accordingly, the shielding performance of the shielding sheet 425 electrically connected to the ground 620 and the plurality of grounds 1210 disposed on the substrate 405 may be prevented from being reduced due to heat.

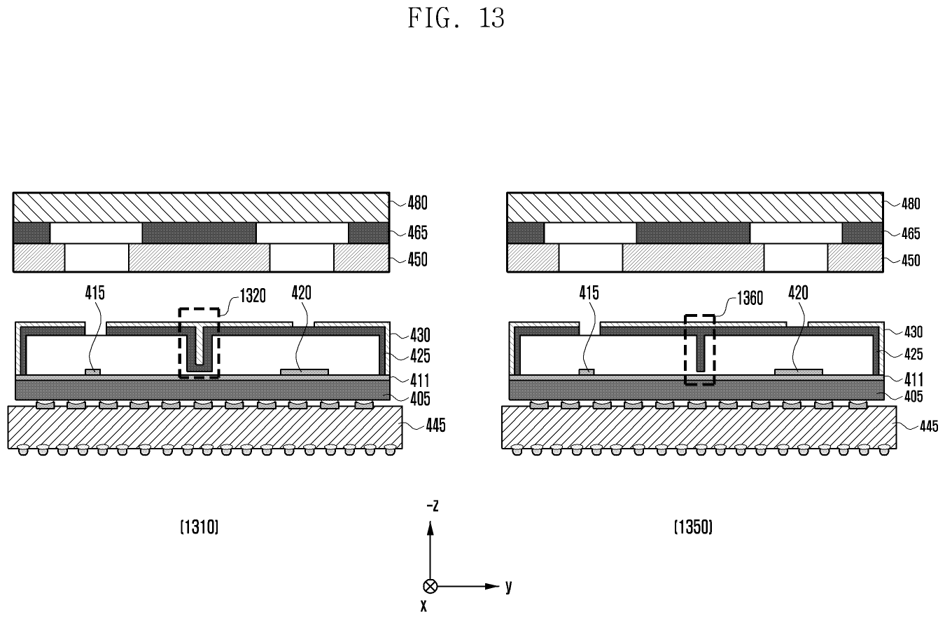

FIG. 13 is a partial cross-sectional view of the electronic device 200 viewed along line A-A′ of FIG. 4A according to an embodiment of the disclosure.

The stacked structure of FIG. 13 according to various embodiments is the same as the stacked structure of FIG. 4B described above, and thus, the description thereof may be replaced with the description related to FIG. 4B. In the following description of FIG. 13, only the configuration different from FIG. 4B will be described.

Referring to FIG. 13, partition walls 1320 and 1360 may be disposed between the light emitter 415 and the first light receiver 420 of the distance measuring sensor 410.

In an embodiment, referring to reference number <1310>, the partition wall 1320 is the sensor housing 430 and may be disposed between the light emitter 415 and the first light receiver 420. In this case, the shielding sheet 425 may be attached following the shape of the partition wall 1320 formed as the sensor housing 430.

In an embodiment, referring to reference number <1350>, the partition wall 1360 is the shielding sheet 425 and may be disposed between the light emitter 415 and the first light receiver 420.

Referring to FIG. 13, the partition walls 1320 and 1360 disposed between the light emitter 415 and the first light receiver 420 may prevent the light generated from the light emitter 415 from being directly introduced into the first light receiver 420.

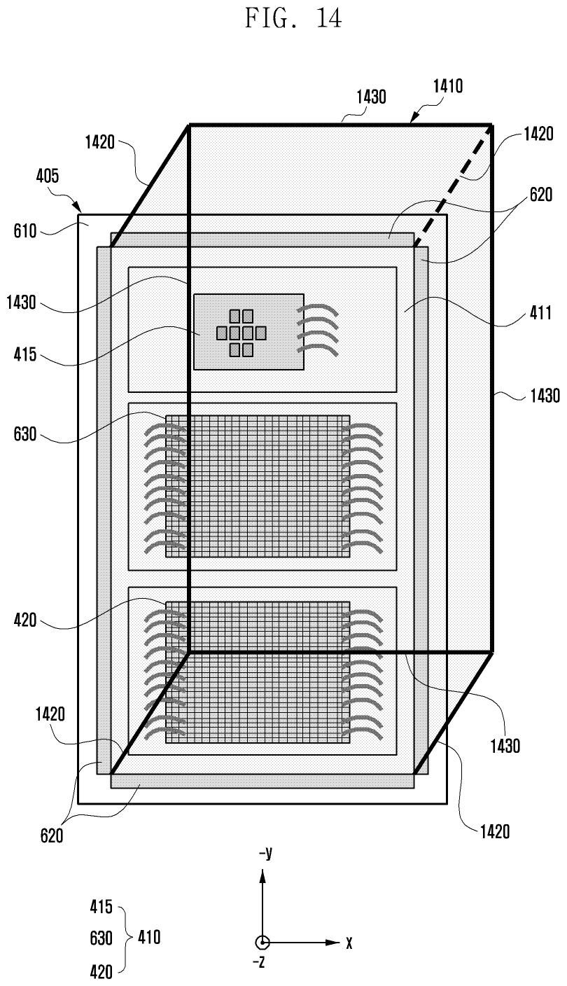

FIG. 14 illustrates a support structure 1410 disposed on the substrate 405 according to an embodiment of the disclosure.

FIGS. 4B, and 5 to 13 according to various embodiments show that a shielding sheet (e.g., the shielding sheet 425 of FIG. 4B) is attached to the inner surface of a sensor housing (e.g., the inner surface 4301 of the sensor housing 430 of FIG. 4B), but is not limited thereto. For example, the shielding sheet 425 may be attached (or placed) to surround the support structure 1410. In this regard, a detailed description will be given in FIG. 14 described later.

Referring to FIG. 14, an electronic device (e.g., the electronic device 200 of FIGS. 2A, 2B, and 3) may include the substrate 405 disposed in the inner space thereof. In an embodiment, the sensor die 411 of the distance measuring sensor 410 including the light emitter 415, the first light receiver 420, and/or the second light receiver 630 may be disposed on the substrate 405. The substrate 405 may include the attachment region 610 and the ground 620 disposed to surround the outer periphery of the substrate 405.

In an embodiment, the electronic device 200 may include the support structure 1410 disposed (or fixed to) on the substrate 405. The support structure 1410 may be formed of, for example, a conductor or conductive material.

In an embodiment, the support structure 1410 may be formed by connecting a plurality of support connectors 1420 and 1430. The plurality of support connectors 1420 and 1430 may include a plurality of vertical connectors 1420 and a plurality of horizontal connectors 1430. For example, the plurality of vertical connectors 1420 may be electrically connected to the ground 620 of the substrate 405.

In an embodiment, the plurality of vertical connectors 1420 may be disposed in a specific direction (e.g., the −z-axis direction) to have a specific length from the corners of the sensor die 411 on which the distance measuring sensor 410 (e.g., the light emitter 415, the first light receiver 420, and/or the second light receiver 630) are disposed.

In an embodiment, the support structure 1410 formed through the plurality of support connectors 1420 and 1430 may have a polygonal shape. For example, the support structure 1410 may have a regular tetrahedral shape or a tetrahedral shape, but is not limited thereto.

In an embodiment, the cross section formed by the plurality of support connectors 1420 and 1430 may have an open shape. For example, the cross section formed by the plurality of support connectors 1420 and 1430 may have, for example, a polygonal shape, such as a square and/or a rectangle.

In an embodiment, the electronic device 200 may include the shielding sheet 425. In FIG. 14 according to an embodiment, the shielding sheet 425 may be arranged to surround the outside of the support structure 1410.

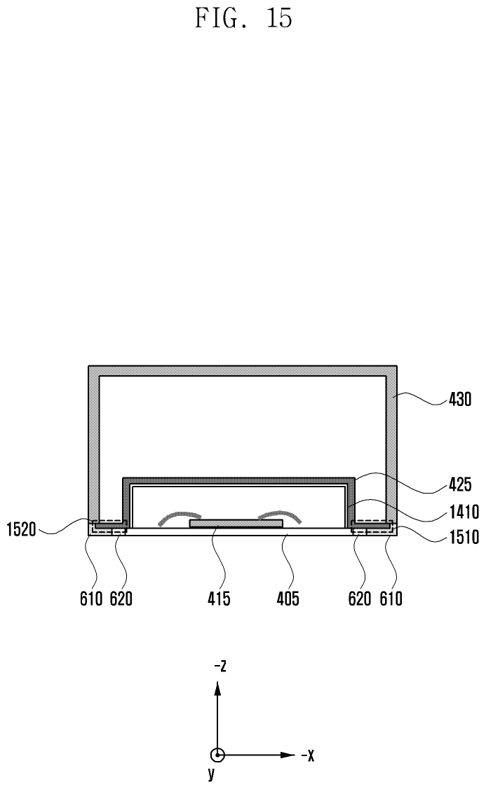

FIG. 15 is a partial cross-sectional view of the electronic device 200 viewed along line B-B′ in FIG. 4A in the structure of FIG. 14, according to an embodiment of the disclosure.

Referring to FIG. 15, an electronic device (e.g., the electronic device 200 of FIGS. 2A, 2B, and 3) may include the distance measuring sensor 410 (e.g., a ToF sensor) configured to detect the distance to an external object. The distance measuring sensor 410 may include the light emitter 415 configured to emit light to the outside, and a first light receiver (e.g., the first light receiver 420 of FIG. 4B) configured to receive the light returned when the light emitted by the light emitter 415 is reflected by the external object. The distance measuring sensor 410 may be disposed on the substrate 405.

In an embodiment, the electronic device 200 may include the support structure 1410 and the sensor housing 430 disposed (or fixed to) on the substrate 405. In an embodiment, the height of sensor housing 430 may be greater than that of support structure 1410.

In an embodiment, the electronic device 200 may include the shielding sheet 425 configured to shield noise generated by the distance measuring sensor 410.

The shielding sheet 425 may be attached in a manner of surrounding the outside of the support structure 1410, but is not limited thereto. Bent parts 1510 and 1520 which have a predetermined length and are bent from the outer edges of the shielding sheet 425 toward the sensor housing 430 in the process of attaching the sensor housing 430 to the attachment region 610 of the substrate 405 may be attached together to the attachment region 610 of the substrate 405. Accordingly, the shielding sheet 425 may be prevented from lifting.

In an embodiment, although not shown, when the inner surface (e.g., the inner surface 4301 of FIG. 4B) of the sensor housing 430 and the inside of the shielding sheet 425 is formed to be conductive, an insulator may be attached to at least a part of the shielding sheet 425 to prevent the distance measuring sensor 410 from being short-circuited.

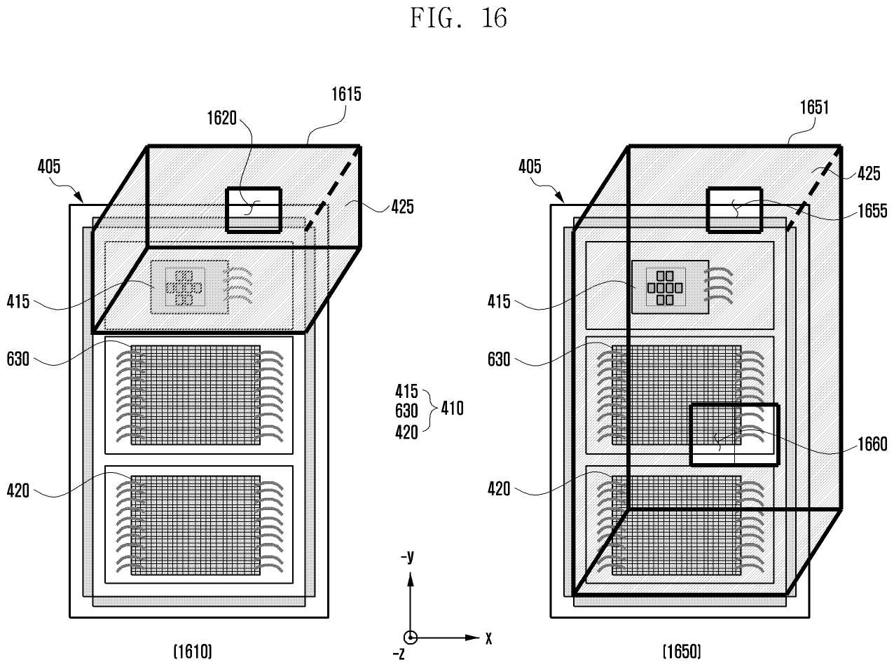

FIG. 16 illustrates the support structures 1615 and 1651 and the shielding sheet 425 disposed on the substrate 405 according to an embodiment of the disclosure.

Referring to FIG. 16, an electronic device (e.g., the electronic device 200 of FIGS. 2A, 2B, and 3) may include the substrate 405 disposed in the inner space thereof. In an embodiment, the electronic device 200 may include a first support structure 1615 and a second support structure 1651 disposed (or fixed to) on the substrate 405.

For example, as shown in reference numeral <1610>, the first support structure 1615 may be disposed in a specific direction (e.g., the −z-axis direction) to have a specific length from the corners in a partial region of the sensor die (e.g., the sensor die 411 of FIG. 4B) on which the light emitter 415 is disposed, to enable the shielding sheet 425 to shield a component, for example, the light emitter 415 of the distance measuring sensor 410, which uses a lot of current. The shielding sheet 425 may be attached (or placed) in a manner of surrounding the outside of the first support structure 1615. In an embodiment, the shielding sheet 425 may include a first opening 1620 (e.g., the third opening 715 of FIG. 7) disposed at a position corresponding to the light emitter 415 of the distance measuring sensor 410.

For another example, as shown in reference number <1650>, the second support structure 1651 may be disposed in a specific direction (e.g., the −z-axis direction) to have a specific length from the corners of the sensor die 411, thereby shielding the distance measuring sensor 410 (e.g., the light emitter 415, the first light receiver 420, and/or the second light receiver 630). The shielding sheet 425 may be attached (or placed) to surround the outside of the first support structure 1615. In an embodiment, the shielding sheet 425 may include a second opening 1655 (e.g., the third opening 715 of FIG. 7) disposed at a position corresponding to the light emitter 415 of the distance measuring sensor 410, and a third opening 1660 (e.g., the fourth opening 720 of FIG. 7) disposed at a position corresponding to the first light receiver 420 of the distance measuring sensor 410.

The area (or size) of the first opening 1620, the second opening 1655, and/or the third opening 1660, illustrated in FIG. 16 according to various embodiments may be determined based on the field of view (FOV) of the distance measuring sensor 410, the height of the support structure 1615 or 1651, the height of the sensor housing 430, and/or the angle of the light emitted by the light emitter 415.

FIGS. 1, 2A, 2B, 3, 4A, 4B, and 5 to 16 according to various embodiments, the shielding sheet 425 may be attached to the inner surface 4301 of the sensor housing 430 mounted on the substrate 405 or may be attached in a manner of surrounding the support structure 1410, 1615, or 1651 disposed on the substrate 405, thereby shielding noise that may occur in the distance measuring sensor 410. For example, the light emitter 415, which is the cause of noise, may be shielded by the shielding sheet 425, except for the path (e.g., the first opening 1620 and the second opening 1655) through which the light is emitted to the outside, thereby minimizing or reducing electromagnetic interference to other surrounding components. In addition, due to the shielding sheet 425 electrically connected to a ground (e.g., the ground 620 of FIG. 6) disposed on the substrate 405, any noise that may arise in the distance measuring sensor 410 may be directed to the ground to minimize or reduce electromagnetic interference to other surrounding components, thereby preventing performance of the distance measuring sensor 410 and/or other components from being degraded.

An electronic device 200 including a distance measuring sensor 410 according to an embodiment of the disclosure may include a housing 210 including a first surface 210A, a second surface 201B facing in a direction opposite to the first surface 210A, and a lateral surface 210C surrounding a space between the first surface 210A and the second surface 201B. The electronic device 200 according to an embodiment may include the distance measuring sensor 410 disposed in the space between the first surface 210A and the second surface 201B, configured to detect the distance to an external object through the second surface 201B, and including a light emitter 415 and a first light receiver 420. The electronic device 200 according to an embodiment may include a substrate 405 on which the distance measuring sensor 410 is disposed. The electronic device 200 according to an embodiment may include a sensor housing 430 disposed on the substrate 405. The electronic device 200 according to an embodiment may include a shielding sheet 425 attached to the inner surface 4301 of the sensor housing 430 to surround the light emitter 415 and the first light receiver 420 and electrically connected to a ground 620 disposed to surround the outer periphery of the substrate 405.

In an embodiment, the shielding sheet 425 may be a film type.

In an embodiment, the substrate 405 may further include an attachment region 610 disposed closer to the outer region than the ground 620 while surrounding the outer periphery of the substrate 405.

In an embodiment, the sensor housing 430 may be disposed on the substrate 405 through the attachment region 610.

In an embodiment, the outer edge of the shielding sheet 425 may have bent parts 815 and 820 which have a predetermined length and are bent from the ends of the shielding sheet 425 toward the sensor housing 430.

In an embodiment, the bent parts 815 and 820 of the shielding sheet 425 may be attached to the substrate 405 through the attachment region 610.

In an embodiment, the sensor housing 430 may include a first upper surface 4302 and a first lateral part 4303 extending to a predetermined depth along the edge of the first upper surface 4302.

In an embodiment, the sensor housing 430 may include a first opening 705 and a second opening 710 disposed through the first upper surface 4302.

In an embodiment, the first opening 705 of the sensor housing 430 may be disposed at a position corresponding to the light emitter 415 of the distance measuring sensor 410.

In an embodiment, the second opening 710 of the sensor housing 430 may be disposed at a position corresponding to the first light receiver 420 of the distance measuring sensor 410.

In an embodiment, the shielding sheet 425 may include a second upper surface 4251 and a second lateral part 4252 extending to a predetermined depth along the edge of the second upper surface 4251.

In an embodiment, the shielding sheet 425 may include a third opening 715 and a fourth opening 720 disposed through the second upper surface 4251.

In an embodiment, the third opening 715 of the shielding sheet 425 may be disposed at a position corresponding to the light emitter 415 of the distance measuring sensor 410.

In an embodiment, the fourth opening 720 of the shielding sheet 425 may be disposed at a position corresponding to the first light receiver 420 of the distance measuring sensor 410.

In an embodiment, the shielding sheet 425 may include a first adhesive layer 1115, a first shielding layer 1160, a second adhesive layer 1165, a second shielding layer 1170, and/or a cover layer 1175.

In an embodiment, the substrate 405 may further include a plurality of grounds 1210 disposed in the central region of the substrate 405.

The electronic device 200 according to an embodiment may further include a partition wall 1320 or 1360 disposed between the light emitter 415 and the first light receiver 420 of the distance measuring sensor 410 and configured to prevent the light generated from the light emitter 415 from being directly introduced into the first light receiver 420.

In an embodiment, the distance measuring sensor 410 may further include a second light receiver 630 disposed between the light emitter 415 and the first light receiver 420 and configured to measure the time during which the light is emitted to the outside by the light emitter 415.

The electronic device 200 according to an embodiment may further include a first support structure 1410 or 1651 disposed on the substrate 405.

In an embodiment, the first support structure 1410 or 1651 may be formed by connecting a plurality of support connectors 1420 and 1430.

In an embodiment, the plurality of support connectors 1420 and 1430 may include a plurality of vertical connectors 1420 and a plurality of horizontal connectors 1430.

In an embodiment, the plurality of vertical connectors 1420 may be electrically connected to the ground 620 of the substrate 405.

In an embodiment, the plurality of vertical connectors 1420 may be disposed in a specific direction to have a specific length from the corners of the sensor die 411 on which the distance measuring sensor 410 is disposed.

In an embodiment, the shielding sheet 425 may be attached to the first support structure 1410 or 1651 to surround the outside of the first support structure 1410 or 1651, instead of being attached to the inner surface 4301 of the sensor housing 430.

The electronic device 200 according to an embodiment may include a second support structure 1615 instead of the first support structure 1410 or 1651.

In an embodiment, the second support structure 1615 may be disposed in a specific direction to have a specific length from the corners in at least a partial region of the sensor die 411 on which the light emitter 415 is disposed, thereby shielding the light emitter 415 of the distance measuring sensor 410.

In an embodiment, the shielding sheet 425 may be attached to the second support structure 1615 to surround the outside of the second support structure 1615.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., through wires), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a housing including:
a first surface,
a second surface facing in a direction opposite to the first surface, and
a lateral surface surrounding a space between the first surface and the second surface;
a distance measuring sensor disposed in the space, configured to detect a distance to an external object through the second surface, and including:
a light emitter, and
a first light receiver;
a substrate on which the distance measuring sensor is disposed;
a sensor housing disposed on the substrate; and
a shielding sheet attached to an inner surface of the sensor housing to surround the light emitter and the first light receiver and electrically connected to a ground disposed to surround an outer periphery of the substrate.

2. The electronic device of claim 1, wherein the shielding sheet is a film type.

3. The electronic device of claim 1, wherein the substrate further comprises an attachment region disposed closer to an outer region than the ground while surrounding an outer periphery of the substrate.

4. The electronic device of claim 3, wherein the sensor housing is disposed on the substrate through the attachment region.

5. The electronic device of claim 3, wherein outer edges of the shielding sheet have bent parts which have a predetermined length and are bent from ends of the shielding sheet toward the sensor housing.

6. The electronic device of claim 5, wherein the bent parts of the shielding sheet are attached to the substrate through the attachment region.

7. The electronic device of claim 1,
wherein the sensor housing comprises a first upper surface and a first lateral part extending to a predetermined depth along an edge of the first upper surface, and
wherein the sensor housing comprises a first opening and a second opening disposed through the first upper surface.

8. The electronic device of claim 7,
wherein the first opening of the sensor housing is disposed at a position corresponding to the light emitter of the distance measuring sensor, and
wherein the second opening of the sensor housing is disposed at a position corresponding to the first light receiver of the distance measuring sensor.

9. The electronic device of claim 1,
wherein the shielding sheet comprises a second upper surface and a second lateral part extending to a predetermined depth along an edge of the second upper surface, and
wherein the shielding sheet comprises a third opening and a fourth opening disposed through the second upper surface.

10. The electronic device of claim 9,
wherein the third opening of the shielding sheet is disposed at a position corresponding to the light emitter of the distance measuring sensor, and
wherein the fourth opening of the shielding sheet is disposed at a position corresponding to the first light receiver of the distance measuring sensor.

11. The electronic device of claim 1, wherein the shielding sheet comprises at least one of a first adhesive layer, a first shielding layer, a second adhesive layer, a second shielding layer, or a cover layer.

12. The electronic device of claim 1, wherein the substrate further comprises a plurality of grounds disposed in a central region of the substrate.

13. The electronic device of claim 1, further comprising:
a partition wall disposed between the light emitter and the first light receiver of the distance measuring sensor and configured to prevent light generated from the light emitter from being directly introduced into the first light receiver.

14. The electronic device of claim 1, wherein the distance measuring sensor further comprises a second light receiver disposed between the light emitter and the first light receiver and configured to measure a time during which light is emitted to an outside by the light emitter.

15. The electronic device of claim 14, further comprising:
a first support structure disposed on the substrate,
wherein the first support structure is formed by connecting a plurality of support connectors, and
wherein the plurality of support connectors comprise a plurality of vertical connectors and a plurality of horizontal connectors.

16. The electronic device of claim 15, wherein the plurality of vertical connectors are electrically connected to the ground of the substrate.

17. The electronic device of claim 15, wherein the plurality of vertical connectors are disposed in a specific direction to have a specific length from corners of the sensor die on which the distance measuring sensor is disposed.

18. The electronic device of claim 15, wherein the shielding sheet is attached to the first support structure to surround an outside of the first support structure, instead of being attached to the inner surface of the sensor housing.

19. The electronic device of claim 15, further comprising:
a second support structure instead of the first support structure,
wherein the second support structure is disposed in a specific direction to have a specific length from corners in at least a partial region of the sensor die on which the light emitter is disposed, thereby shielding the light emitter of the distance measuring sensor.

20. The electronic device of claim 19, wherein the shielding sheet is attached to the second support structure to surround an outside of the second support structure.
